(19) United States
(12) Patent Application Publication
(10) Pub. No.: US 2014/0247015 A1
(43) Pub. Date: Sep. 4, 2014

(54) BATTERY OF PORTABLE ELECTRONIC DEVICE AND OPERATING METHOD THEREOF

(71) Applicant: WISTRON CORPORATION, New Taipei City (TW)

(72) Inventors: Chang-Long Hsu, New Taipei City (TW); Rui-Yi Chen, New Taipei City (TW)

(73) Assignee: Wistron Corporation, New Taipei City (TW)

(21) Appl. No.: 13/864,286

(22) Filed: Apr. 17, 2013

(30) Foreign Application Priority Data
Mar. 1, 2013 (TW) 102107355

(51) Int. Cl. H02J 7/00

(52) U.S. Cl. CPC H02J 7/00
USPC 320/128

(57) ABSTRACT

A battery is provided. The battery includes a battery cell, a connector, a universal serial bus, a first micro control unit and a second micro control unit. The connector has an enable pin for determining whether the battery is electrically connected to a portable electronic device through the connector. The first micro control unit is coupled to the enable pin and the second micro control unit is coupled to the universal serial bus. When it is determined that the battery is connected to the portable electronic device, the first micro control unit is enabled to perform a charge/discharge process on the battery cell through the portable electronic device. When it is determined that the battery is not connected to the portable electronic device, the second micro control unit is enabled to electrically connect the battery cell to the universal serial bus.

### CROSS-REFERENCE TO RELATED APPLICATION

This application claims the priority benefit of Taiwan application serial no. 102107355, filed on Mar. 1, 2013. The entirety of the above-mentioned patent application is hereby incorporated by reference herein and made a part of this specification.

### BACKGROUND OF THE INVENTION

1. Field of the Invention

The present invention relates to an electronic device and an operating method, and more particularly to a battery of a potable electronic device and an operating method thereof

2. Description of Related Art

With development of semiconductor devices and display techniques, electronic devices are continually developed towards directions of miniaturization, multi-function and easy to carry. The commonly used portable electronic devices include personal digital assistants, mobile phones and notebook computers, etc. A structure of the portable electronic device can be folded to reduce an occupation area, so as to achieve miniaturization of the electronic product.

Taking notebook computers as an example, notebook computers nowadays generally includes a battery configured to provide power required for system operations in order to allow users to carry and use the devices anywhere. However, after being separated from the notebook computer system, the battery of notebook computer cannot be further utilized for other purposes. That is, the battery of the notebook computer must be assembled to the notebook computer in order to provide power, and the battery cannot be used as a power supply device for other mobile device once it is separated from the notebook computer system.

### SUMMARY OF THE INVENTION

The invention relates to a battery of a portable device and an operating method thereof, suitable for the battery of the portable device of the portable electronic device to be served as an external mobile power pack when the battery of the portable device is not connected to the portable electronic device.

The invention provides an operating method for a battery of a portable device. The battery of the portable device has a battery cell, a first micro control unit, a second micro control unit, an enable pin and a universal serial bus, the first micro control unit and the second micro control unit are respectively coupled to the battery cell, the first micro control unit is coupled to the enable pin and the second micro control unit is coupled to the universal serial bus, the method includes the followings. Whether the battery of the portable device is electrically connected to a portable electronic device is determined through the enable pin. The first micro control unit is enabled so that a charge/discharge process is performed on the battery cell through the portable electronic device when it is determined that the battery of the portable device is electrically connected to the portable electronic device. The second micro control unit is enabled to electrically connect the battery cell to the universal serial bus when it is determined that the battery of the portable device is not electrically connected to the portable electronic device through the connector.

In the operating method according to an embodiment of the invention, the battery of the portable device further includes a signal switch respectively coupled to the first micro control unit and the battery cell, and the step of enabling the first micro control unit includes turning on the signal switch to electrically connect the battery cell to the portable electronic device.

In the operating method according to an embodiment of the invention, the portable electronic device includes a notebook computer.

In the operating method according to an embodiment of the invention, the step of enabling the second micro control unit to electrically connect the battery cell to the universal serial bus further includes the followings. Whether a voltage of the battery cell is lower than a protective voltage is determined. A discharge process is performed through the universal serial bus when the voltage is not lower than the protective voltage. A charge process is performed through the protective voltage when the voltage is lower than the protective voltage.

In the operating method according to an embodiment of the invention, the portable electronic device further includes a circuit module respectively coupled to the battery cell and the universal serial bus, and the step of enabling the second micro control unit includes: turning on the circuit module by the enabled second micro control unit to electrically connect the battery cell to the universal serial bus.

In the operating method according to an embodiment of the invention, the circuit module includes a voltage converter and a charge pump.

In the operating method according to an embodiment of the invention, a first voltage level of a first terminal of the circuit module coupled to the battery cell is higher than a second voltage level of a second terminal of the circuit module coupled to the universal serial bus.

The invention provides a battery of a portable device. The battery of the portable device includes a battery cell, a connector, a universal serial bus, a first micro control unit and a second micro control unit. The connector has an enable pin which determines whether the battery of the portable device is electrically connected to a portable electronic device through the connector. The first micro control unit is coupled to the enable pin and the second micro control unit is coupled to the universal serial bus, and the first micro control unit and the second micro control unit are respectively coupled to the battery cell. The first micro control unit is enabled so that a charge/discharge process is performed on the potable electronic device when it is determined that the battery of the portable device is electrically connected to the portable electronic device through the connector. The second micro control unit is enabled so that the battery cell is electrically connected to the universal serial bus when it is determined that the battery of the portable device is not electrically connected to the portable electronic device through the connector.

In the portable electronic device according to an embodiment of the invention, the battery of the portable device further includes a signal switch respectively coupled to the connector, the first micro control unit and the battery cell, and the enabled first micro control unit turns on the signal switch to electrically connect the battery cell to the portable electronic device when it is determined that the battery of the portable device is electrically connected to the portable electronic device through the connector.

In the portable electronic device according to an embodiment of the invention, the portable electronic device includes a notebook computer.

In the portable electronic device according to an embodiment of the invention, the battery of the portable device further includes a circuit module respectively coupled to the second micro control unit, the battery cell and the universal serial bus, and the enabled second micro control unit turns on the circuit module to electrically connect the battery cell to the universal serial bus when the second micro control unit is enabled.

In the portable electronic device according to an embodiment of the invention, the circuit module includes a voltage converter and a charge pump.

In the portable electronic device according to an embodiment of the invention, a first voltage level of a first terminal of the circuit module coupled to the battery cell is higher than a second voltage level of a second terminal of the circuit module coupled to the universal serial bus.

Based on the above description, according to a voltage level of the enable pin, whether the battery of the portable device is connected to the portable electronic device is determined. Accordingly, the first micro control unit and the second micro control unit are enabled or disabled respectively. Therefore, when the battery of the portable device is connected to the portable electronic device through the connector, the second micro control unit is disabled while the first micro control unit is enabled, so that the battery of the portable device can perform a charge/discharge process through the portable electronic device. On the other hand, when the battery of the portable device is separated from the portable electronic device, the first micro control unit is disabled while the second micro control unit is enabled, so that the battery cell of the electronic device can be electronically connected to the universal serial bus and served as an mobile power pack for other external mobile devices.

To make the above features and advantages of the invention more comprehensible, several embodiments accompanied with drawings are described in detail as follows.

### BRIEF DESCRIPTION OF THE DRAWINGS

FIG. 1 is a schematic view of a battery of a portable device according to an embodiment of the invention.

FIG. 2 is a flowchart of an operating method according to an embodiment of the invention.

FIG. 3 is a flowchart showing steps of enabling the second micro control unit to electrically connect the battery cell to the universal serial bus according to the operating method the invention.

### DESCRIPTION OF THE EMBODIMENTS

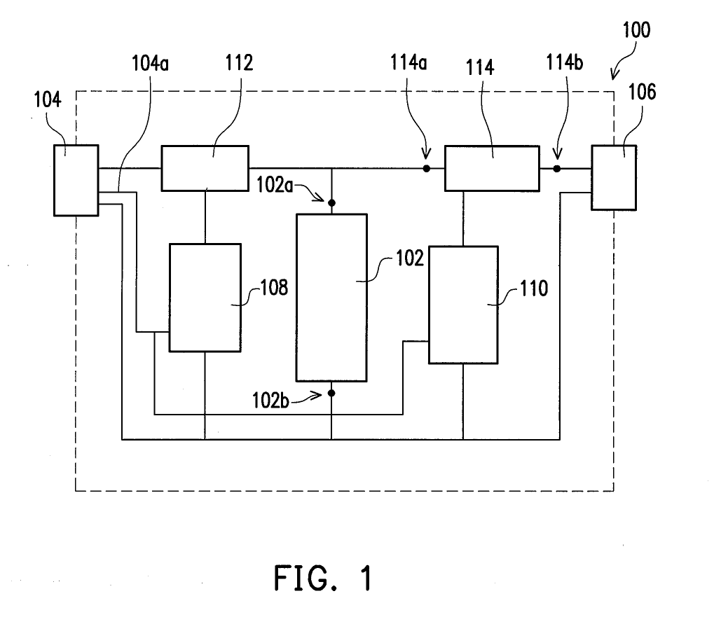

FIG. 1 is a schematic view of a battery of a portable device according to an embodiment of the invention. Referring to FIG. 1, the battery 100 of the portable device of the present embodiment includes a battery cell 102, a connector 104, a universal serial bus (USB) 106, a first micro control unit (MCU) 108 and a second micro control unit 110. Among them, the battery 100 of the portable electronic device can be, for example, a battery of a notebook computer. That is, the battery 100 of portable electronic device is connected to a potable electronic device (in the present embodiment, the notebook computer is used as an example) through the connector 104, and configured to provide power to the portable electronic device through the connector 104 (i.e. a discharge process of the battery 100) or perform a charge process through the connector 104.

In addition, the battery cell 102 is respectively coupled to the first micro control unit 108 and the second micro control unit 110, so as to respectively provide power to the first micro control unit 108 and the second micro control unit 110. Furthermore, the battery cell 102 is coupled to the connector 104. When the portable electronic device is connected to the battery 100 of the portable electronic device through the connector 104, the battery cell 102 can provide power to the portable electronic device through the connector 104 or perform the charge process through the connector 104 and the portable electronic device. And, in the embodiment depicted in FIG. 1, a positive electrode and a negative electrode of the battery cell 102 (such as terminals 102a and 102b of the battery cell 102) are respectively electrically connected to the same connector 104. Nonetheless, the present invention is not limited thereto. The positive electrode and the negative electrode of the battery cell 102 can be electrically connected together on the same connector 104 as shown in the embodiment depicted in FIG. 1, or can be respectively electrically connected to different connecting positions based on actual configuration location design of a battery connector of the portable electronic device.

In addition, the connector 104 has an enable pin 104a, and whether the battery 100 of the portable electronic device is electrically connected to the portable electronic device can be determined through the connector 104. In the present embodiment, the enable pin 104a is respectively coupled to the first micro control unit 108 and the second micro control unit 110. For instance, when the electronic device battery 100 is connected to the portable electronic device through the connector 104, the enable pin 104a is grounded due to a circuit design of the battery connector of the portable electronic device. Therefore, the voltage level of the enable pin 104a is logic 0. When the voltage level of the enable pin 104a is logic 0, the first micro control unit 108 is enabled and the second micro control unit 110 is disabled accordingly since the enable pin 104a is respectively coupled to the first micro control unit 108 and the second micro control unit 110. Therefore, the first micro control unit 108 controls the battery cell 102 to perform a charge/discharge process through the connector 104 and the portable electronic device.

In yet another embodiment, the battery 100 of the portable electronic device further includes a signal switch 112, which is respectively coupled to connector 104, the first micro control unit 108 and the battery cell 102. Accordingly, when it is determined that the battery 100 of the portable electronic device is connected to the portable electronic device through the connector 104, the enabled first micro control unit 108 controls and turns on the signal switch, so as to electrically connect the battery cell 102 to the portable electronic device through the connector 104.

Moreover, the second micro control unit 110 is further coupled to the universal series bus 106. For instance, when it is determined that the electronic device battery 100 is not electrically connected to the portable electronic device (that is, the battery 100 of the portable electronic device is separated from the portable electronic device), the enable pin 104a is not connected to the battery connector of the portable electronic device, so that the enable pin 104a is not connected to the ground and the voltage level thereof is logic 1. As a result, when the voltage level of the enable pin 104a is logic 1, the first micro control unit 108 is disabled while the second micro control unit 110 is enabled accordingly, so as to electrically connect the battery cell 102 to the universal serial bus 106.

In yet another embodiment, the battery 100 of the portable electronic device further includes a circuit module 114 respectively coupled to the second micro control unit 110, the battery cell 102 and the universal series bus 106. Therefore, when it is determined that the battery 100 of the portable electronic device is separated from the portable electronic device and the second micro control unit 110 is enabled, the enabled second micro control unit 110 controls and turns on the circuit module 114, so as to electrically connect the battery cell 102 to the universal series bus 106. For instance, the circuit module 114 as described above includes a voltage converter and a charge pump. The voltage converter further includes a direct current/direct current voltage converter.

For instance, when the battery 100 of the portable electronic device is the battery of the notebook computer, an output voltage of the battery cell 102 is approximately 7.4 to 11.1 volts. When the battery 100 of the portable electronic device is separated from the electronic device and served as a mobile power pack for providing power to other mobile devices, the output voltage of the battery is approximately 5 volts.

Therefore, the voltage output from the battery cell 102 requires a step-down process through the charge pump in the circuit module 114. Moreover, when the battery 100 of the portable electronic device is separated from the portable electronic device and connected to an external power through the universal series bus 106 for performing a charge process to charge the battery cell 102, a step-up process is performed through the charge pump in the circuit module 114, so as to boost the input voltage (approximately 5 volts) of the external power to the voltage of the battery cell 102 (approximately 7.4 to 11.1 volts). More specifically, a first voltage level of a first terminal 114a of the circuit module 114 coupled to the battery cell 102 is higher than a second voltage level of a second terminal 114b of the circuit module 114 coupled to the universal serial bus.

In the present invention, whether the battery 100 of the portable electronic device is connected to the portable electronic device can be determined based on a voltage level of the enable pin 104a. Accordingly, the first micro control unit 108 and the second micro control unit 110 are respectively enable or disable. That is, based on the voltage level of the enable pin, the first micro control unit 108 and the second micro control unit 110 can respectively perform operations opposite to each other. Therefore, when the battery 100 of the portable electronic device is connected to the portable electronic device through the connector 104, the second micro control unit 110 is disabled while the first micro control unit 108 is enabled. Thus, the charge/discharge process of battery can be performed on the battery 100 of the portable electronic device through the portable electronic device. Furthermore, when the battery 100 of the portable electronic device is separated from the portable electronic device, the first micro control unit 108 is disabled while the second micro control unit 110 is enabled. Therefore, the battery cell 102 of battery 100 of the portable electronic device is electrically connected to the universal serial bus 106, such that the electronic device can serve as a mobile power pack and the charge/discharge process can be performed on the battery 100 through the universal serial bus 106 connected to a power source or other mobile devices.

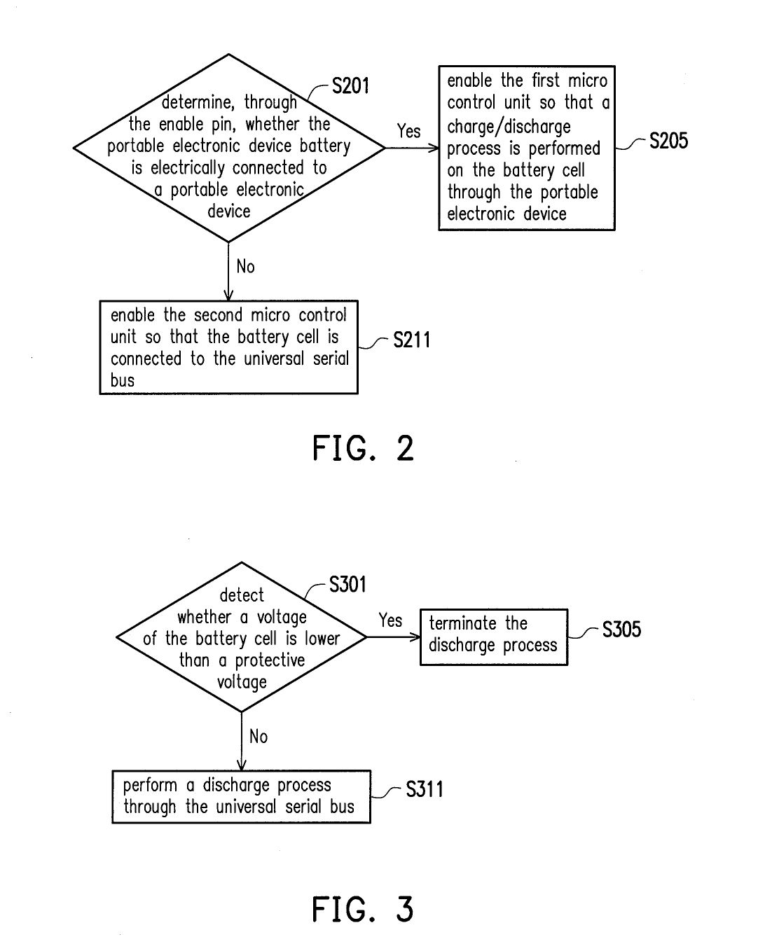

The following embodiment in association with the accompanied drawings is served to further describe the method for operating the battery of the portable electronic device. FIG. 2 is a flowchart of an operating method according to an embodiment of the invention. Referring to FIG. 1 and FIG. 2 together, in step S201, whether the battery 100 of the portable electronic device is electrically connected to a portable electronic device (not illustrated) is determined through the enable pin 104a. In step S205, the first micro control unit 108 is enable so that a charge/discharge process is performed on the battery cell 102 through the portable electronic device when it is determined that the battery 100 of the portable electronic device is electrically connected to the portable electronic device. On the other hand, in step S211, the second micro control unit 110 is enabled so that the battery cell 102 is electrically connected to the universal serial bus 106 when it is determined that the battery 100 of the portable electronic device is not electrically connected to the portable electronic device through the connector 104. In the aforementioned steps (S205 and S211), steps of enabling the first micro control unit 108 to control and turn on the signal switch 112 so that the battery cell 102 is electrically connected to the portable electronic device through the connector 104, and enabling the second micro control unit 110 to turn on circuit module 114 so that the battery cell 102 is electrically connected to the universal serial bus 106, have been described in the aforementioned embodiment, thus it is not repeated hereinafter.

FIG. 3 is a flowchart showing steps of enabling the second micro control unit to electrically connect the battery cell to the universal serial bus according to the operating method the invention. Referring to FIG. 3, step S211 of enabling the second micro control unit 110 to electrically connect the battery cell 102 to the universal serial bus 106 further includes detecting whether a voltage of the battery cell 102 is lower than a protective voltage as shown in step S301. In step S305, when the voltage of battery cell 102 is lower than the protective voltage, the second micro control unit 110 interrupts an electrical connection between the battery cell 102 and the universal serial bus 106. That is, a discharge path from the battery cell 102 to the universal serial bus 106 is switched off as to stop the battery cell 102 from performing a discharge process continuously through the universal serial bus, such that lifetime and security of the battery cell 102 can both be improved. Furthermore, under the circumstance of the voltage of the battery cell 102 being lower than the protective voltage, when the battery 100 of the portable electronic device is connected to an external power source through the universal serial bus 106, a charge process on the battery cell 102 can be performed through the universal serial bus 106.

In step S311, when the voltage of the battery cell 102 is not lower than the protective voltage, the universal serial bus 106 performs a discharge process to an external mobile device connected to the battery 100 of the portable electronic device through the universal serial bus 106 (that is, charging the external mobile device).

In summary, in the present invention, based on a voltage level of the enable pin, whether the battery of the portable electronic device is connected to the portable electronic device is determined. Accordingly, the first micro control unit and the second micro control unit are enabled or disabled respectively. Therefore, when the battery of the portable electronic device is connected to the portable electronic device through the connector, the second micro control unit is disabled while the first micro control unit is enabled, so that the battery of the portable electronic device can perform a charge/discharge process through the portable electronic device. On the other hand, when the battery of the portable electronic device is separated from the portable electronic device, the first micro control unit is disabled while the second micro control unit is enabled, so that the battery cell of the electronic device can be electronically connected to the universal serial bus and served as an mobile power pack for other external mobile devices.

Although the present invention has been described with reference to the above embodiments, it will be apparent to one of ordinary skill in the art that modifications to the described embodiments may be made without departing from the spirit of the invention. Accordingly, the scope of the invention will be defined by the attached claims and not by the above detailed descriptions.

What is claimed is:

1. An operating method for a battery of a portable electronic device, wherein the battery of the portable electronic device has a battery cell, a first micro control unit, a second micro control unit, an enable pin and a universal serial bus, the first micro control unit and the second micro control unit are respectively coupled to the battery cell, the first micro control unit is coupled to the enable pin and the second micro control unit is coupled to the universal serial bus, the method comprises:
determining, through the enable pin, whether the battery of the portable electronic device is electrically connected to the portable electronic device;
enabling the first micro control unit so that a charge/discharge process is performed on the battery cell through the portable electronic device when it is determined that the battery of the portable electronic device is electrically connected to the portable electronic device; and
enabling the second micro control unit to electrically connect the battery cell to the universal serial bus when it is determined that the battery of the portable electronic device is not connected to the portable electronic device.

2. The operating method of claim 1, wherein the battery of the portable electronic device further comprises a signal switch respectively coupled to the first micro control unit and the battery cell, and the step of enabling the first micro control unit comprises turning on the signal switch to electrically connect the battery cell to the portable electronic device.

3. The operating method of claim 1, wherein the portable electronic device comprises a notebook computer.

4. The operating method of claim 1, wherein the step of enabling the second micro control unit to electrically connect the battery cell to the universal serial bus comprises:
detecting whether a voltage of the battery cell is lower than a protective voltage;
performing a discharge process through the universal serial bus when the voltage is not lower than the protective voltage; and
terminating the discharge process by the second micro control unit when the voltage is lower than the protective voltage.

5. The operating method of claim 1, wherein the portable electronic device further comprises a circuit module respectively coupled to the battery cell and the universal serial bus, and the step of enabling the second micro control unit comprises:
disabling the first micro control unit; and
turning on the circuit module by the enabled second micro control unit to electrically connect the battery cell to the universal serial bus.

6. The operating method of claim 5, wherein the circuit module comprises a voltage converter and a charge pump.

7. The operating method of claim 5, wherein a first voltage level of a first terminal of the circuit module coupled to the battery cell is higher than a second voltage level of a second terminal of the circuit module coupled to the universal serial bus.

8. A battery of a portable electronic device, comprising:
a battery cell;
a connector, wherein the connector has an enable pin, and whether the battery of the portable electronic device is electrically connected to a portable electronic device through the connector is determined through the enable pin;
a universal serial bus;
a first micro control unit, wherein the first micro control unit is coupled to the enable pin;
a second micro control unit, wherein the second micro control unit is coupled to the universal serial bus, and the first micro control unit and the second micro control unit are respectively coupled to the battery cell, and:
the first micro control unit is enabled so that a charge/discharge process is performed on the battery cell through the potable electronic device when it is determined that the battery of the portable electronic device is electrically connected to the portable electronic device through the connector; and
the second micro control unit is enabled so that the battery cell is electrically connected to the universal serial bus when it is determined that the battery of the portable electronic device is not electrically connected to the portable electronic device through the connector.

9. The battery of the portable electronic device of claim 8, wherein the battery of the portable electronic device further comprises a signal switch respectively coupled to the connector, the first micro control unit and the battery cell, and the enabled first micro control unit turns on the signal switch to electrically connect the battery cell to the portable electronic device when it is determined that the battery of the portable electronic device is electrically connected to the portable electronic device through the connector.

10. The battery of the portable device of claim 8, wherein the portable electronic device comprises a notebook computer.

11. The battery of the portable device of claim 8, wherein the battery of the portable electronic device further comprises a circuit module respectively coupled to the second micro control unit, the battery cell and the universal serial bus, and the enabled second micro control unit turns on the circuit module to electrically connect the battery cell to the universal serial bus when the second micro control unit is enabled.

12. The battery of the portable device of claim 11, wherein the circuit module comprises a voltage converter and a charge pump.

13. The battery of the portable device of claim 11, wherein a first voltage level of a first terminal of the circuit module coupled to the battery cell is higher than a second voltage level of a second terminal of the circuit module coupled to the universal serial bus.
